(19) United States
(12) Patent Application Publication
(10) Pub. No.: US 2017/0015235 A1
(43) Pub. Date: Jan. 19, 2017

(54) LIGHT DEVICE FOR A MOTOR VEHICLE

(71) Applicant: Valeo Vision, Bobigny Cedex (FR)

(72) Inventors: Jean-Claude Puente, Livry Gargan (FR); Christine Roucoules, Deuil La Barre (FR); Stephane Bourgeois, Paris (FR); Pierre Albou, Paris (FR)

(21) Appl. No.: 15/171,084

(22) Filed: Jun. 2, 2016

(30) Foreign Application Priority Data
Jun. 8, 2015 (FR) 1555195

(51) Int. Cl. B60Q 1/00; F21S 8/10

(52) U.S. Cl. CPC B60Q 1/0005; B60Q 1/0023; F21S 48/328; F21S 48/335; F21S 48/1225; F21S 48/1388; F21S 48/115; F21Y 2115/10

(57) ABSTRACT

A light device 1 for a motor vehicle comprising:
at least one first aperture for air, and
a first plug for the at least one first aperture,
the first plug being movable between a ‘closed’ position and an ‘open’ position of the first aperture.

The light device thus makes it possible to achieve:
efficient ventilation, when the plug is in the open position, particularly when the vehicle is moving, and
relative obstruction to the ingress of dust and liquids, when the plug is in the closed position, particularly when the vehicle is stationary.

### CROSS-REFERENCE TO RELATED APPLICATIONS

This application claims priority to the French application 1555195 filed Jun. 8, 2015, which application is incorporated herein by reference and made a part hereof.

### BACKGROUND OF THE INVENTION

1. Field of the Invention

The invention relates to the automotive industry.

The invention relates more particularly to a light device for a motor vehicle comprising at least one air inlet or outlet aperture.

2. Description of the Related Art

Light devices of this type are known for the purpose of lighting and/or signaling in particular. Such devices include a taillight, a headlight or a lighting and/or signaling device for the vehicle interior. When such devices comprise at least one air inlet or outlet aperture, they have the advantage of allowing a greater flow of air between the inside and the outside, particularly when the vehicle is in motion. By virtue of this ventilation, the moisture contained in the light device can be effectively extracted to limit the condensation of water vapor inside the light device. However, because the apertures are constantly open, dust and liquids, such as rainwater, can get in relatively easily, whether the vehicle is stationary or moving.

There are also lighting devices as described above which further comprise an impermeable membrane arranged jointly with the at least one first aperture. The membrane is, more specifically, impermeable to liquids and dust and permeable to air, so that the ingress of dust and water into the light device is advantageously limited. However, as a result ventilation is also limited, even when the vehicle is in motion, so that the condensation of water vapor inside the light device cannot be effectively limited.

Note that the advantages and disadvantages of each of the ventilation systems of light devices described above should be analyzed according to the geographical area in which the vehicle is traveling or is intended to travel: one ventilation system will be preferred in a hot and humid climate; another system will be preferred in a temperate climate zone.

### SUMMARY OF THE INVENTION

With the above in mind, the present invention provides a light device for a motor vehicle that overcomes one or more of the aforementioned disadvantages.

To this end, the light device of the invention, which also conforms to the generic definition given in the preamble above, is essentially such that it further comprises a first plug for the at least one first aperture, the first plug being movable between a ‘closed’ position and an ‘open’ position of the first aperture.

In other words, the first plug is mounted so as to be able to move between a ‘closed’ position and an ‘open’ position of the first aperture.

The light device thus makes it possible to achieve circulation of air within the light device to limit the condensation of water on the outer lens of the light device and/or dispel heat generated by the light source.

The light device also achieves:

efficient ventilation, when the plug is in the open position, whether the vehicle is moving or stationary, and

relative obstruction to the ingress of dust and liquids, when the plug is in the closed position, particularly when the vehicle is stationary.

The first aperture is located at the front or rear of the light device.

According to one feature, the light device further comprises a first plug actuator for moving the first plug between the closed position and the open position of the first aperture.

According to one feature, the light device further comprises an actuator control device for controlling the first actuator for moving the first plug.

The light device thus advantageously has automated actuation of the plugs.

According to another feature, the light device further comprises a second aperture for air. The light device may further comprise a second plug for the second aperture. The second plug may be arranged so as to be moved together with the first plug of the first aperture or to be moved independently of the first plug of the first aperture.

According to one feature, the light device further comprises a second plug actuator for moving the second plug between the closed position and the open position of the second aperture.

According to one feature, the actuator control device is also intended for controlling a second actuator for moving the second plug. The actuator control device may simultaneously control the first actuator and the second actuator for moving the first plug and the second plug. Each actuator may also be operated manually.

According to other features taken alone or in combination:

at least one plug, preferably each plug, comprises a membrane which is impermeable to liquids and to dust and permeable to air, and/or

each plug has a shape and/or dimensions adapted to allow a controlled flow of air between the inside and the outside of the light device, when the plug is in the closed position, and/or

at least one actuator is a shape memory actuator, a motorized actuator, or a solenoid actuator, and/or

the control device comprises a dew point sensor and/or a humidity sensor and/or a vehicle speed sensor, and/or

the control device is designed to receive a measurement signal from a sensor fitted to the vehicle and to control at least one actuator as a function of the measurement signal.

According to another feature, the light device comprises an additional aperture for the outlet of air from inside the light device, the additional aperture having a plug movable between a ‘closed’ position and an ‘open’ position of the additional aperture in the event of excess pressure.

According to another feature, the light device comprises at least one light source. This light source comprises at least one semiconductor emitting element, in particular a light emitting diode.

These and other objects and advantages of the invention will be apparent from the following description, the accompanying drawings and the appended claims.

### BRIEF DESCRIPTION OF THE ACCOMPANYING DRAWINGS

Further features and advantages of the invention will become clearly apparent from the description which is given below, by way of non-limiting example, with reference to the accompanying drawings, in which:

FIG. 1 shows a perspective view of a headlight for a motor vehicle;

FIG. 2 shows a sectional view of a light device according to an embodiment of the invention with the plugs in the closed position;

FIG. 3 shows a sectional view of a light device according to the embodiment of the invention shown in FIG. 1, with the plugs in the open position;

FIG. 4 shows a perspective view of a plug according to an embodiment of the invention;

FIG. 5 shows a block diagram of the light device according to an embodiment of the invention; and

FIG. 6 shows a block diagram of the light device according to another embodiment of the invention.

### DETAILED DESCRIPTION OF THE PREFERRED EMBODIMENTS

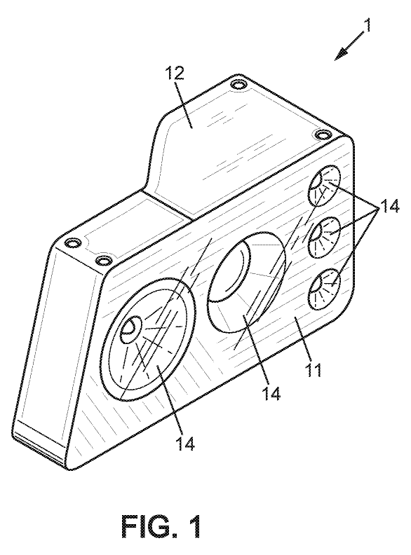

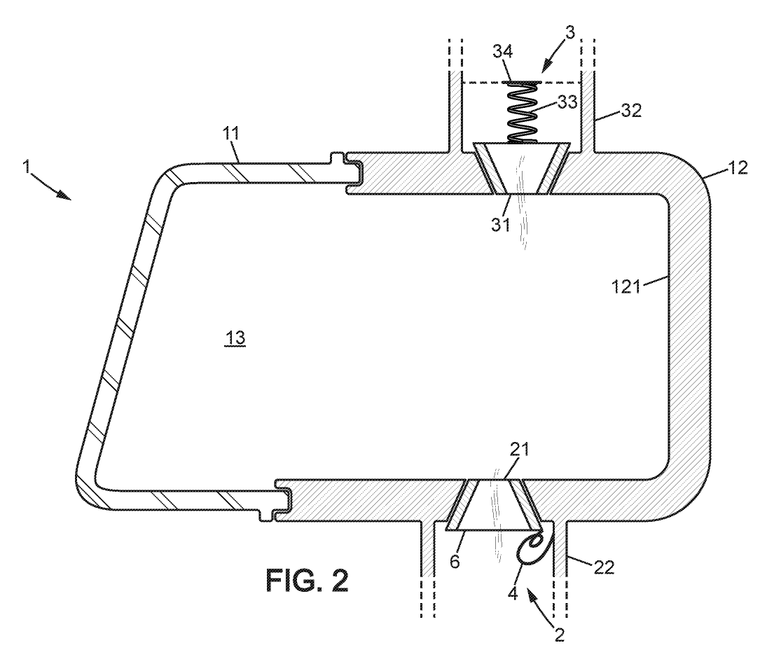

As shown in FIGS. 1 and 2, a light device 1 or a motor vehicle 0 generally comprises an outer lens 11 and a concave housing 12. The outer lens 11 is positioned opposite the concavity of the housing 12 so as to form a substantially impermeable enclosure 13. Typically, the inner surface 121 (FIG. 2) of the housing 12 may be at least partially reflective and at least one light source 14 may be arranged in the concavity thereof to perform various signaling and/or lighting functions. In one additional or alternative embodiment, the housing 12 comprises at least one reflector arranged in the concavity and intended to interact with the light source 14 to perform various signaling and/or lighting functions. For example, the light source 14 may comprise at least one semiconductor emitting element; it may, more specifically, be a light emitting diode.

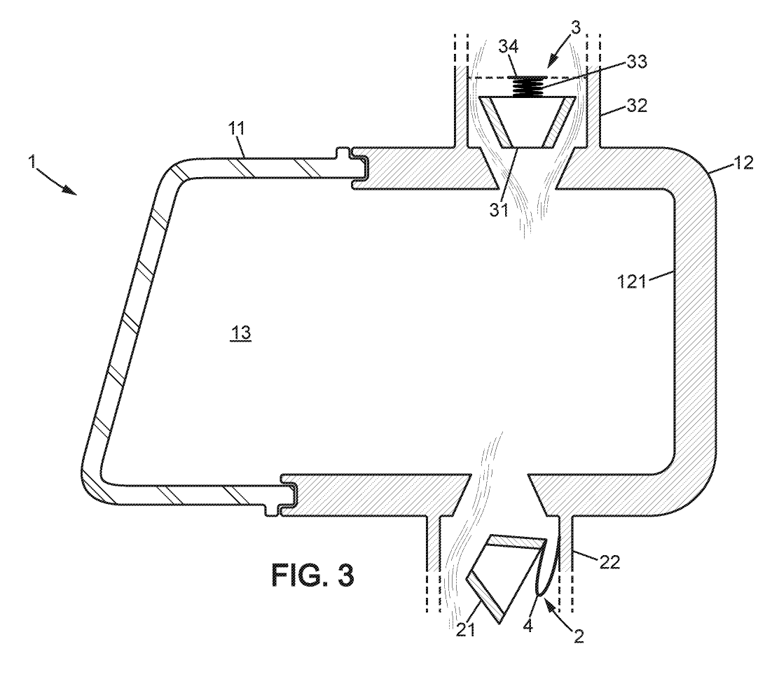

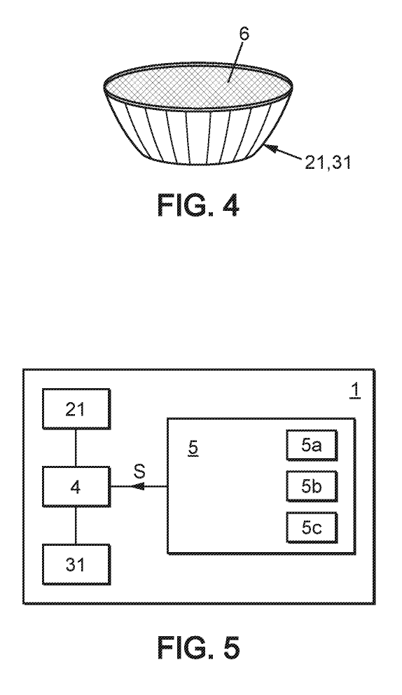

As shown in FIGS. 2 and 3, the light device 1 according to the invention comprises at least one first air aperture 2. This at least one first aperture 2 may more particularly be an aperture for the inlet or intake of air from outside the light device 1 to the inside of the light device 1. The light device 1 may further comprise at least one second air aperture 3. This second aperture 3 allows air to flow from outside or inside the light device 1. This second aperture 3 may more particularly be an aperture for the outlet and/or expulsion of air from the inside of the enclosure 13 of the light device 1 to the outside of the light device 1. The first and second apertures 2, 3 are preferably formed in the housing 12 of the light device 1. The second aperture 3 allows the air taken in through the first aperture 2 to be expelled. Such an aperture is desirable to promote circulation of air between the inside and the outside of the enclosure 13 of the light device 1, and may be necessary to prevent the air pressure in the light device 1 from exceeding a threshold value above which the light device 1 could be damaged.

According to the embodiment shown in FIGS. 2 and 3, the first and second apertures 2, 3 are made through the sidewalls of the housing 12 of the light device 1.

In an additional or alternative embodiment, at least one of the first and second apertures 2, 3 may be positioned at the front of the light device 1, in particular on the outer lens 11 of the light device 1. It may then be protected by part of the motor vehicle 0 to increase the efficiency of the effect of excess pressure during motion.

As shown in FIGS. 2 and 3, each of the first and second apertures 2, 3 may extend outward of the headlight or light device 1 by a cylindrical wall 22, 32. A tube (not shown) may be positioned on each aperture, and more particularly may be fitted onto the cylindrical wall extending each of the first and second apertures 2, 3. A tube positioned on the first air aperture 2 may be oriented, for example forming a bend, toward the front of the motor vehicle 0, to present an optimal air intake when the motor vehicle 0 is moving forward. By contrast, a tube positioned on the outlet or second aperture 3 may be oriented toward the rear of the motor vehicle 0 and may also have baffles against the ingress of dust and liquids into the light device 1.

The light device 1 according to the invention further comprises at least one plug 21 positioned on the first aperture 2 and a plug actuator 4. According to a preferred embodiment, another plug 31 may be positioned on the second aperture 3. In addition, a single actuator 4 may be arranged to move a plurality of plugs 21, 31 or each plug 21, 31 may be associated with an actuator 4 of its own.

Each aperture plug 21, 31 may be moved by an actuator 4 between an ‘aperture closed’ position and an ‘aperture open’ position. The actuator 4 may also be designed to move each plug 21, 31 into an intermediate position between the closed position and the open position thereof; ventilation of continuously variable efficiency may thus be obtained.

Each plug 21, 31 may be made of polymer and/or metal and/or rubber.

The plug 21, 31 may be cylindrical or frustoconical or any other shape designed to at least partially obstruct the first or second aperture 2 or 3 with which it is associated. In FIG. 3, the plug 21, 31 is frustoconical. It may be solid, but preferably has at least one through hole allowing an exchange of air between the outside and the inside of the light device 1.

Each plug 21, 31 may further comprise at least one membrane 6 which is impermeable to liquids and dust and permeable to air. The membrane 6 may be woven. The membrane 6 is more particularly arranged on the at least one through hole in each plug 21, 31. Thus, when the plugs 21, 31 are in the closed position, there continues to be an exchange of air between the inside and the outside of the light device 1.

The amount of air exchanged when the plugs 21, 31 are in the closed position depends on the surface area of the through hole and whether or not there is a membrane 6. The through hole in a plug 21, 31 may be cylindrical; it is preferably frustoconical or any other shape designed to aerodynamically control acceleration or deceleration of the airflow passing therethrough. When a membrane 6 is present, the amount of air exchanged then depends on the porosity of the membrane 6.

The amount of air exchanged is however lower than the amount of air exchanged when the plugs 21, 31 are in the open position. This feature is illustrated in FIGS. 2 and 3 by the curved broken lines passing through the first aperture 2 and the second aperture 3, the curved broken lines in FIG. 2 with the plugs 21, 31 in the closed position being less numerous than the curved broken lines in FIG. 3 with the plugs in the open position.

When the light device 1 comprises a plurality of plugs 21, 31, they may be moved together, so that, at any one time, they are all in the closed position or all in the open, or relatively open, position.

The lighting system makes it possible to achieve:

efficient ventilation when the plugs 21, 31 are in the open position, whether the motor vehicle 0 is moving or stationary, and

relative obstruction to the ingress of dust and liquids when the plugs 21, 31 are in the closed position, particularly when the vehicle is stationary.

Alternatively, when the light device 1 comprises a plurality of plugs 21, 31, they may be moved independently.

As shown in FIGS. 2 and 3, the plug 31 of the second aperture 3 may not be associated with an actuator 4. Indeed, advantageously, the outlet plug 31 may be moved by virtue of changes in pressure in the light device 1, such changes being related to the inlet plug 21 being moved from the closed position to the open position, or vice versa. The outlet plug 31 thus functions as a valve:

kept in the open position when the pressure inside the headlight is higher than a predetermined threshold value, in particular when the inlet plug 21 is in the open position, and

kept in the closed position when the pressure inside the headlight is lower than a predetermined threshold value, in particular when the inlet plug 21 is in the closed position. To this end, a return means, such as a shape memory part or a solenoid or a spring 33 arranged in conjunction with a stop 34 may be used to exert, on the valve, a force for returning the valve to the closed position.

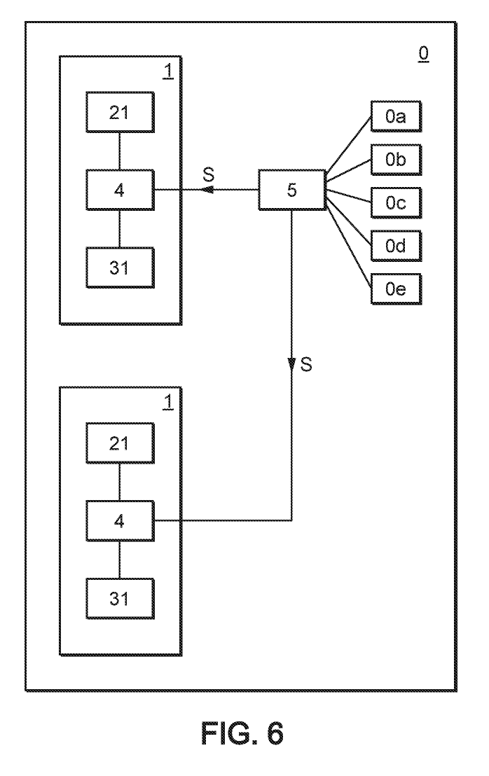

Operation of at least one plug 21, 31 by the actuator 4 may be manual. The driver of the motor vehicle 0 may for example operate the plug 21, 31 himself. However, as shown in FIGS. 5 and 6, it is advantageously envisaged to automate the operation of the plugs 21, 31 by means of a control device 5 for the actuator 4. The control device 5 is thus arranged to send a control signal S to the actuator 4 which moves the plug 21, 31 according to this control signal S.

For example, the actuator 4 is a shape memory actuator, a motorized actuator or a solenoid actuator, and the control device 5 sends the actuator 4 a predetermined control signal S, such as an electrical current, to change the position of the plug 21, 31. The actuator 4 shown in FIGS. 2 and 3 is a shape memory actuator.

Preferably, each plug 21, 31 is in the closed position when no control signal S is supplied to the actuator 4 by the control device 5. This avoids having to issue a control signal S to the actuator 4, in particular when the motor vehicle 0 is stationary or when there is no condensation. This prevents the entry of water and/or moisture and/or dust in the event of abrupt changes in the weather, for example. The use of a digital control signal S may also be considered; however, the actuator 4 should then be provided with suitable processing means, which may entail an additional cost.

The control signal S sent by the control device 5 to the actuator 4 may be a function of a measurement signal relating to a value detected by a sensor specific to the control device 5 or by a sensor fitted to the motor vehicle 0 and intended to be operatively connected to the control device 5.

As shown in FIG. 5, the sensors belonging to the control device 5 may include at least one of a dew point sensor 5a, a humidity sensor 5b and a vehicle speed sensor 5c. In an additional or alternative embodiment, a camera may be arranged jointly with the outer lens 11 of the light device 1 to detect whether the outer lens 11 is steamed up or not. The dew point sensor 5a and the humidity sensor 5b may be arranged directly in the light device 1, preferably near the outer lens 11 to provide a direct measurement relating to the air contained inside the enclosure of the light device 1. The speed sensor 5c may be a pitot tube arranged for example so that it opens out at the front of the light device 1. According to this embodiment, it may be advantageous for the control device 5 to be arranged inside the enclosure of the light device 1 or near thereto. In addition, the light device 1 according to this embodiment may manage its own ventilation autonomously, and may in particular comprise a source of power.

As shown in FIG. 6, the control device 5 may be intended to be connected to one or more sensors already known to be fitted in motor vehicles 0. Such sensors include, for example, a vehicle wheel rotation speed sensor 0a, an accelerometer 0b, a rain sensor 0c, a sensor 0d for detecting whether the engine of the motor vehicle 0 is stopped or running, a sensor 0e for detecting the humidity of the ambient air, etc. According to this embodiment, the control device 5 may be positioned remotely from the light device 1; it is thus advantageously possible to centralize control of the ventilation of a plurality of light devices 1 of a motor vehicle 0. The control device 5 is thus arranged to receive a measurement signal from a sensor fitted to the motor vehicle 0 and to control at least one actuator (4) based on the measurement signal.

It must be obvious to the person skilled in the art that the control device 5 may benefit from coupling measurements from sensors that are specific to the light device 1 and sensors that are fitted to the motor vehicle 0 in a known manner.

The light device 1 according to the embodiments described above offers a wide range of operating modes.

For example, when the light device 1 contains dry air and is located in a humid and/or dusty environment, ventilation with a low coefficient of exchange is adapted; the plugs 21, 31 are in the closed position.

As another example, when the ambient air is not humid and there is no dust, ventilation with a high coefficient of exchange is adapted; the plugs 21, 31 are in the open position.

As another example, when the dew point is reached inside the light device 1, thus indicating a high level of internal condensation, ventilation with a high coefficient of exchange is adapted; the plugs 21, 31 are in the open position.

As another example, when the vehicle speed exceeds a threshold value, for example 10 km/h, the plugs 21, 31 are automatically moved to the open position, to benefit from the dynamic effect of the motor vehicle 0, especially when the ambient air is dry and dust-free.

According to a kinematic example:

when humidity below the dew point is measured, the plugs 21, 31 are in the closed position, then

when the humidity increases and reaches or exceeds the dew point, the plugs 21, 31 are moved to the open position, then

when the humidity falls below the dew point once more, the plugs 21, 31 are moved to the closed position.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A light device for a motor vehicle comprising:
least one first aperture for air, and
a first plug for said at least one first aperture,
said first plug being movable between a closed position and an open position of said at least one first aperture.

2. The light device according to claim 1, comprising a first plug actuator for moving said first plug between said closed position and said open position of said at least one first aperture.

3. The light device according to claim 2, comprising an actuator control device for controlling said first plug actuator for moving first plug.

4. The light device according to claim 1, comprising a second aperture for air.

5. The light device according to claim 4, comprising a second plug for said second aperture.

6. The light device according to claim 5, wherein said second plug is arranged so as to be moved together with said first plug of said at least one first aperture.

7. The light device according to claim 5, comprising said actuator control device for controlling a second actuator for moving said second plug.

8. The light device according to claim 7, wherein said actuator control device simultaneously controls said first plug actuator and said second actuator for moving said first plug and said second plug.

9. The light device according to claim 1, wherein at least one of said first plug and said second plug comprises a membrane which is impermeable to liquids and to dust and permeable to air.

10. The light device according to claim 5, wherein each of said first plug has a shape adapted to allow a controlled flow of air between an inside and an outside of the light device, when each plug and said second plug is in the said closed position.

11. The light device according to claim 5, wherein each of said first plug and said second plug has dimensions adapted to allow a controlled flow of air between an inside and an outside of the light device, when the each of said first plug and said second plug is in the said closed position.

12. The light device according to claim 3, wherein said actuator control device comprises a dew point sensor and/or a humidity sensor and/or a vehicle speed sensor.

13. The light device according to claim 3, wherein said actuator control device is designed to receive a measurement signal from a sensor fitted to said motor vehicle and to control at least one actuator as a function of said measurement signal.

14. The light device according to claim 1, wherein said light device further comprises a housing adapted to house at least one reflector and at least one light source operatively associated with said at least one reflector.

15. The light device according to claim 14, wherein the light device further comprises a lens coupled to said housing.

16. The light device according to claim 14, comprising a second plug for said second aperture.

17. The light device according to claim 16, wherein said second plug is arranged so as to be moved together with said first plug of said at least one first aperture.

18. The light device according to claim 17, comprising said actuator control device for controlling a second actuator for moving said second plug.

19. The light device according to claim 17, wherein each of said first plug and said second plug has a shape adapted to allow a controlled flow of air between an inside and an outside of the light device, when each of said first plug and said second plug is in said closed position.

20. The light device according to claim 17, wherein each of said first plug and said second plug has dimensions adapted to allow a controlled flow of air between an inside and an outside of the light device, when each of said first plug and said second plug is in said closed position.
